(19) United States
(12) Patent Application Publication
(10) Pub. No.: US 2011/0157024 A1
(43) Pub. Date: Jun. 30, 2011

(54) SYSTEM-EXPANDABLE REMOTE CONTROL WITH TOUCH PANEL, AND METHOD FOR EXPANDING SYSTEMS

(76) Inventor: Gary Chao, Taipei City (TW)

(21) Appl. No.: 12/648,665

(22) Filed: Dec. 29, 2009

(51) Int. Cl. G06F 3/041

(52) U.S. Cl. 345/173

(57) ABSTRACT

Provided is a remote control with touch panel and an operating system, and the remote control is a system-expandable device. In accordance with an embodiment, the remote control at least includes a data processing unit, a display unit for displaying the virtual control interface, and accompanied with a touch-panel screen provided for user's manipulation. The remote control further has a communication unit for expanding the remote-control program modules via a network, and a memory unit for storing the modules supporting various devices to be controlled. In addition to the stored modules inside the memory unit, the expanding method is further provided for supporting the various devices to be controlled by downloading the remote-control program modules regarding unsupported devices via network. The remote-control program module, more particularly, includes a virtualized remote-control interface, remote-control key definition, and a remote-control instruction set.

### BACKGROUND OF THE INVENTION

1. Field of the Invention

A remote control with touch panel equipped with an operating system platform is a system-expandable remote control, and a method for expanding system, more particularly to the remote control having an expandable memory which provides extra remote-control program modules in accordance with various systems to be remotely controlled.

2. Description of Related Art

With well development of wireless remote control using an infrared, especially to the household appliances, provided is a great convenience for people. However, every household appliance requires a proprietary remote control since the applications using wireless remote control are steadily on the increase, the more on-hand remote controls and the more torments are formed.

Although a so-called universal remote control, which declares for supporting various appliances, are sold on the market, the functions are still limited and can not be applied to every equipment. Even though the universal remote control declares that it supports many appliances made by different manufacturers since it has an instruction library, it still fails to support many various and special functions of the modern appliances.

### SUMMARY OF THE INVENTION

With the well developments of the touch-control technologies and hand-held devices, and required to handle the various applications using the wireless remote control, the present invention provides a system-expandable remote control having a built-in operating system platform, and using a touch panel. A method for expanding the subsystems made by the remote control is further disclosed. More particularly, the remote control has a memory which is component-expandable. The memory stores a library having the programs of various manufacturers and different devices to be controlled. An external memory medium is moreover provided to store other remote-control program modules.

Furthermore, the external memory can be implemented as a memory card in accordance with a hot plug input/output technology, or a computer memory which is accessed through USB. More, a downloadable space over a network is also available, so that an extra remote-control program module can be downloaded. After installation, the remote control is capable of conforming to various remotely-controlled functionalities. The provided technology advantages the manufacturers not to offer redundant remote controls, and concurrently have environmental clean, energy saving and carbon reduction, and moreover provide convenient and expandable advantages.

According to one of the embodiments, the system-expandable remote control with touch panel firstly includes a data processing unit capable of performing signal processing, and computation. A display unit is particularly provided to display a virtual remote-control interface, which has exchangeable icons of the remote-control software, buttons and their positions, or optionally a menu of virtual remote-control interfaces. The display unit is accompanied with a one-touch type or a multiple-touch type touch unit, whereby the touch signals are generated as users manipulate the virtual remote-control interface on the display unit.

The preferred remote control with touch panel further includes a communication unit that provides a signaling interface of the remote-control program module besides transmitting the signals to the device to be controlled [symbol] . Provided is a hot-plug connecting port linking the external computers, such as USB, and a network connecting port to network. More particularly, a memory unit of the remote control with touch panel has a library for recording one or more remote-control program modules for a plurality of devices to be controlled.

When a remote-control program module is activated, the bundled virtual remote-control interface, plural remote-control key definitions, and a remote-control instruction set are loaded for controlling a corresponding device.

The method for expanding system using the above-described remote control, according to one of the embodiments, includes a first step of determining whether the remote control supports to control a specific device to be controlled. In which, a matching procedure is used to perform the detection. If the matching is not successful, the remote control does not support the device. Alternatively, a menu of virtual remote-control interfaces shown on a screen can be used to make the determination. If the remote control supports the device, a remote-control program module with corresponding device to be controlled is executed. Otherwise, if there is no any module available, an interface with hot plug input/output technology, USB, or via a network is used to load an extra remote-control program module.

### BRIEF DESCRIPTION OF THE DRAWINGS

The foregoing aspects and many of the attendant advantages of this invention will be more readily appreciated as the same becomes better understood by reference to the following detailed description, when taken in conjunction with the accompanying drawings, wherein:

FIG. 1 is a schematic diagram of the in-use system-expandable remote control with touch panel of the present invention;

FIG. 2 shows a schematic diagram of one embodiment of the system-expandable remote control of the present invention;

FIG. 3 shows another diagram of the embodiment of the system-expandable remote control with touch panel;

FIG. 4 is an embodiment of the system-expandable remote control with touch panel adapted to a network;

FIG. 5 is an electrical block diagram of the system-expandable remote control with touch panel;

FIG. 6 is a flow chart of the method for expanding system of the present invention.

### DETAILED DESCRIPTION OF THE PREFERRED EMBODIMENTS

Remote control provides a convenient way to manipulate a remote device. More devices are required to use remote control to operate the functions. The device to be controlled itself is not equipped with a complex control panel any more, on the contrary, a proprietary remote control is provided instead for manipulating the advanced functionality. Even if the well-known universal remote control is used, it still fails to handle the comprehensive features.

With the well developments of the touch-control technologies and hand-held devices, the present invention particularly provides a system-expandable remote control with touch panel, and a method for expanding the system using the same. The invention makes the claimed remote control supporting more and widespread remotely-controlled technologies. Particularly, the remote control further adopts the well-developed touch-control technology.

To a device to be controlled, it is possible to develop the claimed remote control to include the comprehensive features it supports. The devices, including television, video recorder, music player, 3C products, and even the household appliances such as air conditioner and electric fan, are the supported subjects to be controlled in accordance with the present invention.

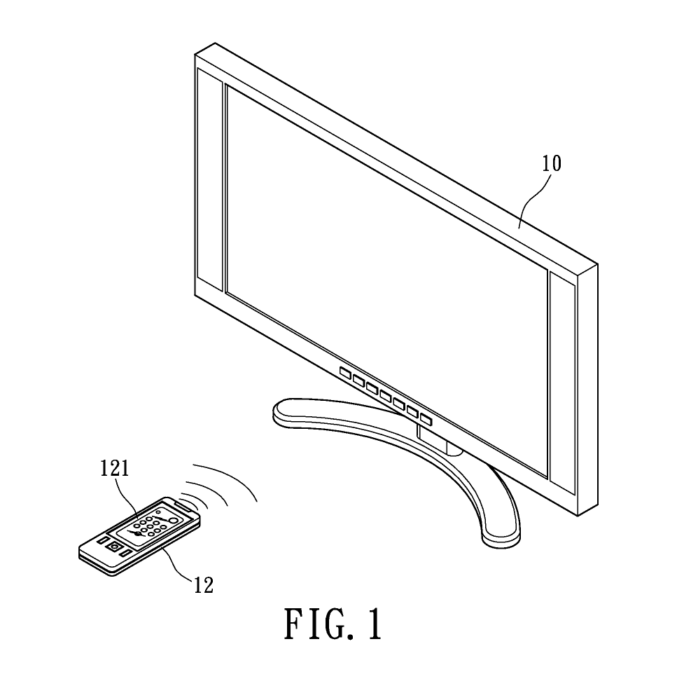

More particularly, a touch-control technology is applied and a displayer is used to display the functions with corresponding to a specific remote control. A virtual remote-control interface is particularly used to simulate the appearance and buttons of a tangible remote control. Furthermore, the virtual remote control can be made by a customized procedure. A user can manipulate the virtual remote control by touching the screen, just like the way to use the common remote control. Reference is made to FIG. 1 drawing a schematic diagram of a system-expandable remote control with touch panel.

In the figure, a user uses a remote control 12 to control a television 10. The external of the remote control 12 has a displayer, especially a touch screen 121 which makes the user manipulating by touching. It is primarily featured that a virtual remote-control interface displayed on the remote control 12 shows a simulated pattern having proprietary functional buttons for the television 10. The virtual remote-control interface is preferably identical to the tangible one. In which, the remote-control key definition of the buttons, and the related functions are required to be supported by the manufacturer. Once the manufacturer is in support, a proprietary remote-control program module can be provided. The remote-control program module can be a package that bundles the mentioned virtual remote-control interface, file of remote-control key definition, and a remote-control instruction set.

Because the claimed remote control is required to support the various devices to be controlled, the system-expandable remote control with touch panel 12 of the present invention provides a component-expandable memory. The memory records a library having the programs relating the diverse manufacturers and different devices to be controlled. The provided expandability is implemented by a downloading method over a network for obtaining the additional remote-control program modules. The additional modules are used to conform to the functions of multiple systems.

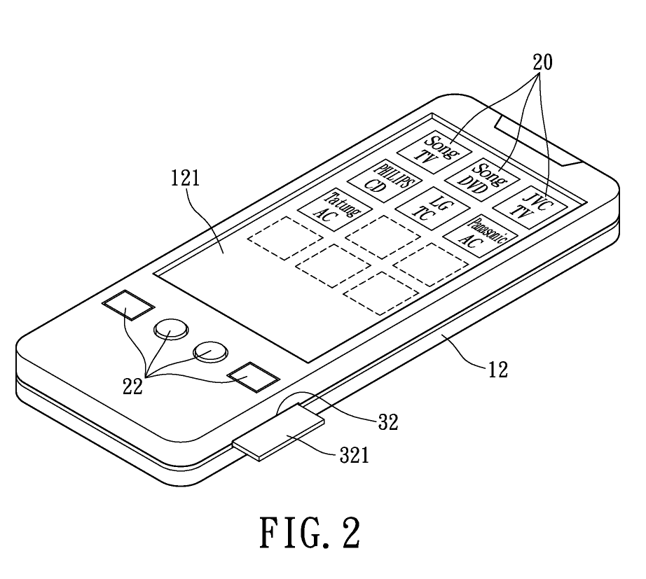

FIG. 2 depicts an embodiment of the system-expandable remote control with touch panel. A menu listing various virtual remote-control interfaces is shown. Users may select one remote-control program module on the list to conform to a device to be controlled.

The menu of the virtual remote-control interfaces shows one or more icons representing the remote-control program modules. In the exemplary example shown in the diagram, the remote-control module icons 20 represent various manufacturers and devices including Sony TV, Sony DVD, JVC TV, PHILIPS CD, LG TV, Panasonic AC, and Tatung AC. Alternatively, a check list menu is another way to show the various remote-control program modules. Some other convenient ways are not limited in the present invention. Besides the displayer including the touch screen 121 and the housing, the external of remote control is disposed with some control buttons 22 providing some basic functions, such as network linking, and items selection. Additionally, a memory card slot 32 is disposed on the remote control 12 for increasing the expandability. A memory card 321 is used to store some other remote-control program modules, which are prepared to be loaded in the remote control 12.

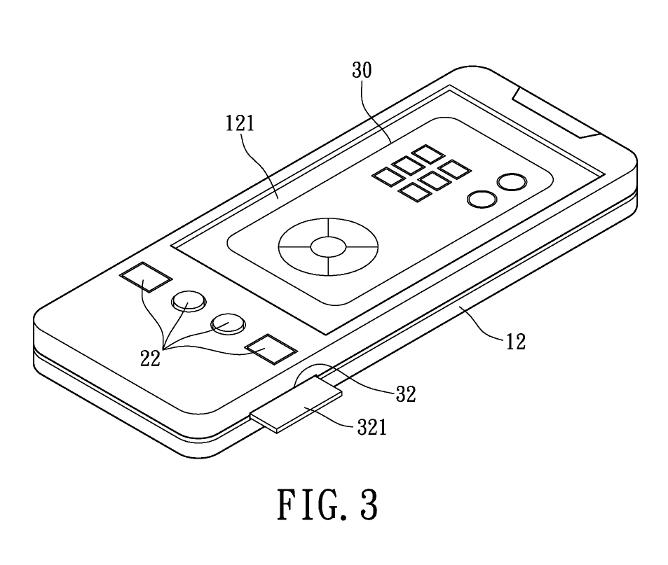

FIG. 3 draws an embodiment of a virtual remote-control interface shown on the remote control with touch panel 12. When the user selects one of the items in the menu of FIG. 2, a remote-control program module associated with the item is executed. The remote-control program module can be a package bundled with a virtual remote-control interface, a file of remote-control key definition, and a remote-control instruction set. The package is extracted as execution. The extracted content includes a virtual remote-control interface 30 displayed on the touch screen 121, and the corresponding remote-control key definition for interpreting the key codes and the related procedure. The related instructions in the remote-control instruction set are transmitted to the corresponding device to be controlled.

Through the claimed remote control shown in FIG. 2 or FIG. 3, the manufacturer of a device to be controlled may not provide the proprietary but redundant remote control, and only the remote-control program module in accordance with the proprietary remote control is required. The remote-control program module should conform to a regulation in compliance with the system-expandable remote control with touch panel 12 of the present invention. It is noted that the remote-control program module can be provided by the manufacturer or at a special server. Users may download the module from the server, or take from a memory medium, such as optical disk, floppy disk or a memory card. Optionally, the memory in a computer system accessed via USB is also available. The claimed system-expandable remote control takes environmental clean, convenience and expandability into account. Since most of the system-expandable remote controls have already equipped with the basic computer functions with embedded operating system, the remote control can provide auxiliary features with entertainment and communication.

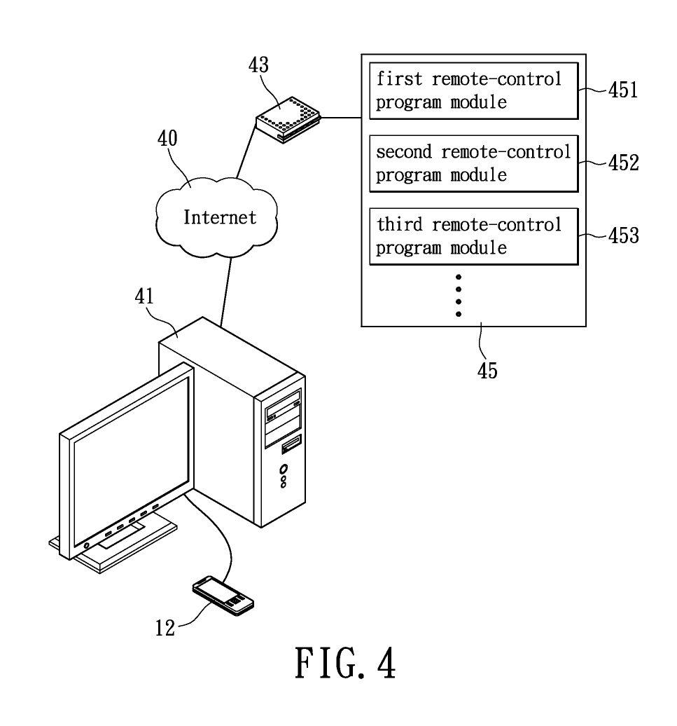

Reference is made to FIG. 4 showing a schematic diagram of the system-expandable remote control with touch panel of the present invention. The claimed remote control is particularly capable of downloading modules over a network. For example, the remote control with touch panel 12 shown in the diagram does not function to link the network directly, but connect to a computer system 41. A synchronous program for driving the remote control 12 has been installed in the computer system 41, and the remote control 12 can link to Internet 40 through this computer system 41. After that, the required remote-control program module is downloaded from a special download server 43.

In practical, the manufacturer of a device to be controlled provides the remote-control program module to a third-party store, and for users to download. Alternatively, the manufacturer can prepare his own download server. As shown in the diagram, the download server 43 has a database having a first remote-control program module (451), a second remote-control program module (452), and a third remote-control program module (453). Therefore, the users can download a remote-control program module from the download server 43 according to this embodiment. After that, the remote control 12 loads the remote-control program module through the computer system 41.

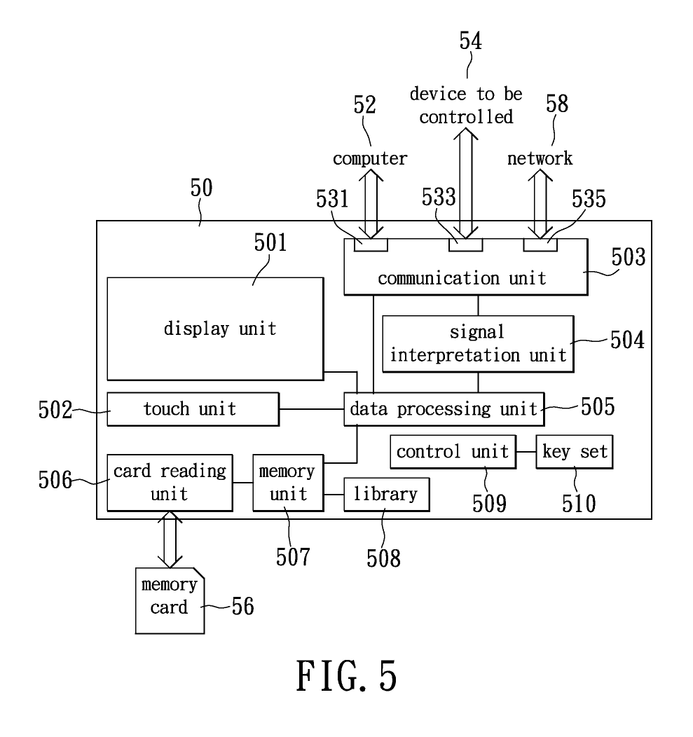

The electrical block diagram shown in FIG. 5 illustrates the functional features of the system-expandable remote control with touch panel.

Accordingly, the remote control primarily has the electrically-interconnected a display unit 501, a touch unit 502, a communication unit 503 and inside computer connecting port 531, signal transmit port 533 and network connecting port 535, and moreover, includes a signal interpretation unit 504, a data processing unit 505, a card reading unit 506, a memory unit 507 and inside library 508, a control unit 509 and its connected key set 510.

The display unit 501 is used to display a virtual remote-control interface for simulating the interface of a tangible remote control, or a menu listing the plural virtual remote-control interfaces. The system-expandable remote control with touch panel 50 particularly applies one-touch or multiple-touch type touch unit 502. This touch unit 502 electrically connects to the display unit 501. Thereby users can manipulate the claimed remote control on the virtual remote-control interface using the touch-control functioned on the screen. The generated information including touching signals and the related position is delivered to the data processing unit 505. The data processing unit 505 can be embodied by a DSP or a micro-processor.

The communication unit 503 is electrically connected to the data processing unit 505. The communication unit 503 is an interface for the system-expandable remote control 50 to external. One or more interfaces, such as a connecting port 531 to computer system 52, a network connecting port 535 to network 58, and a signal transmit port 533 for transmitting command to the device 54 to be controlled.

The remote control 12 connects the computer system 52 via the connecting port 531, and there-through links to network for downloading or updating the remote-control program module. Some auxiliary functions, such as backup and electric charging, can be included. The computer system 52 is functioned to load other digital contents into the remote control 50, in which a hot plug input/output technology such as a memory card is employed, or the wired (such as USB) or wireless connection (such as Bluetooth) is used. The remote control 12 can also has its own networking function. More, a network connecting port in the communication unit 503 can be implemented as a wired (such RJ45) or wireless (such as WiFi, 3G or the like) connection. By a network routing means, the network 58 is linked for downloading the mentioned remote-control program module, or achieve other purposes of communication.

The signal transmit port 533 is used to transmit the control commands to the device to be controlled 54, thereby to remotely control the device. The signals can be compliance with infrared ray or RF. The communication unit 503, in some embodiments, further includes the various connecting ports for multimedia, such as HDMI, IEEE1394 and the like well-known standards.

The remote control 50 further has a memory unit 507, which is electrically connected to the data processing unit 505, is adapted to store an embedded operating system and the relevant data to the operation thereof. In particular, the memory unit 507 has a library 508 for recording the installed remote-control program modules for supporting one or more devices to be controlled. In addition to download the remote-control program module corresponding to the specific device to be controlled over the network, the system-expandable remote control 50 further equips with a card reading unit 506 in compliance with a hot plug input/output technology. The card reading unit 506 is electrically connected to the memory unit 507, and used for accessing an external memory card 56. Furthermore, the memory in the computer system 52 is also used for providing the modules via USB. Still further, other types of memory medium are also available to the invention. For an instance, users may load more remote-control program modules via the memory card 56 for an expandable matter.

Since the system-expandable remote control with touch panel 50 is required to support various devices to be controlled, and the device may provide many proprietary functions besides some usual matters, the system-expandable remote control 50 employs a signal interpretation unit 504. The unit 504, which is electrically connected to the data processing unit 505, is used for interpreting the remote-control key definition, and instruction set extracted from the remote-control program module in accordance with a specific device. Therefore, the claimed remote control is matched with the commands to the device to be controlled.

Furthermore, the remote control with touch panel 50 has a control unit 509 connected with a key set 510. The control unit 509 is used to provide the basis manipulation for the claimed remote control 50, which includes some legacy buttons.

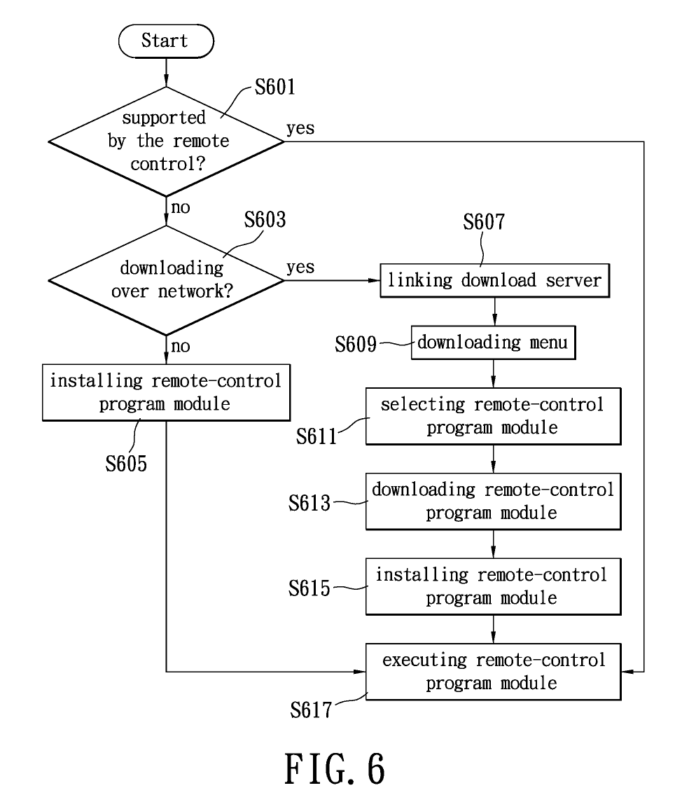

Reference is made to a flow chart shown in FIG. 6. The flow chart illustrates the method for expanding the systems in the claimed system-expandable remote control of the present invention.

In the beginning, it's to prepare a system-expandable remote control with touch panel and its peripherals. The preparation includes a process to determine a device to be controlled, and a corresponding remote-control program module is loaded as the device to be controlled is selected.

In the next step S601, it's to determine whether the system-expandable remote control with touch panel is able to control the device to be controlled or not. A matching procedure can be used to identify the current condition, and check whether or not the device is supported. If the matching procedure fails, it shows the system-expandable remote control does not support the functions of the device to be controlled. More, since the menu listing the virtual remote-control interfaces will display all the installed remote-control program modules, the menu can be used to check if the remote control supports the selected device.

If the remote control is available to the device to be controlled, the corresponding remote-control module needs to be selected and executed as described in step S617. In another embodiment, the step further determines whether or not there is an update for the module. The related update information can be found in the download server. The module can be executed after an updating process.

If the remote control does not yet support the selected device to be controlled, the step S603 is in progress to determine whether the remote-control program module is downloaded over the network. The remote control in accordance with the present invention may use some other memory medium such as the read reader in compliance with the hot plug input/output technology for accessing an external memory card or the memory in computer system (via USB) to acquire the extra remote-control program module. If the step does not find the way to download over the network, it shows the external memory medium is used to load the specific remote-control program module. If the module is downloaded over the network, the module is stored into the memory unit of the remote control. In step S605, the remote-control program module is installed. The step S617 is then to be performed.

If the step determines the module is required to be downloaded over the network, the method goes to step S607. The step is to link to a download server which provides the files supplied by manufacturers, or by the third party who is responsible for coding the remote-control program module, and provided for downloading. The implementation can be referred to the above description regarding FIG. 4.

Next, the step in the method is to download a menu (step S609). The menu lists the online supported modules for user's selection (step S611). A selected remote-control program module is downloaded afterward. It is noted that the remote-control program module can be a package which is convenient to acquire. This package includes a virtual remote-control interface, a file of remote-control key definition, and a remote-control instruction set. Each module at least supports at least one device to be controlled (step S613). The remote-control program module is loaded in further step S615. At last step S617, the remote-control program module is executed.

In summation of above description, the system-expandable remote control with touch panel in accordance with the embodiment of the present invention is provided. Further the method for expanding system for the remote control is also claimed. The remote control with touch panel particularly has a touch-control type displayer. It is featured that the various devices can be supported by means of downloading the remote-control program module with corresponding device to be controlled.

The above-mentioned descriptions represent merely the preferred embodiment of the present invention, without any intention to limit the scope of the present invention thereto. Various equivalent changes, alternations or modifications based on the claims of present invention are all consequently viewed as being embraced by the scope of the present invention.

What is claimed is:

1. A system-expandable remote control with touch panel, comprising:
a data processing unit;
a display unit for displaying a virtual remote-control interface or a menu of a plurality of virtual remote-control interfaces;
a touch unit electrically connected with the data processing unit and the display unit, whereby a touch signal is generated as a user uses the virtual remote-control interface;
a communication unit electrically connected to the data processing unit, including one or more types of interfaces for external communication of the system-expandable remote control with touch panel; and
a memory unit electrically connected to the data processing unit, wherein the memory unit has a library used for storing remote-control program modules supporting one or more devices to be controlled;
wherein one virtual remote-control interface, one remote-control key definition, and one remote-control instruction set bundled in one remote-control program module are loaded as one of the remote-control program modules is activated.

2. The remote control of claim 1, wherein the touch unit is formed by a one-touch type or a multiple-touch type touch panel.

3. The remote control of claim 1, wherein the communication unit includes a connecting port linking to a computer system, and a signal transmit port of the device to be controlled for transmitting a remote-control instruction.

4. The remote control of claim 1, wherein the communication unit includes a network connecting port linking to a network, and a signal transmit port of the device to be controlled for transmitting a remote-control instruction.

5. The remote control of claim 1, wherein the communication unit includes:
a connecting port, by which the remote control connects to a computer system by a wired or wireless connecting means;
a signal transmit port used to transmit a remote-control instruction to the device to be controlled; and
a network connecting port, by which the remote control connects to a network by a wired or wireless connecting means.

6. The remote control of claim 5, further comprising a control unit and an electrically-connected key set, which provide basic manipulations for the remote control.

7. The remote control of claim 1, further comprising a signal interpretation unit electrically connected to the data processing unit, and the remote-control key definition and the remote-control instruction set are interpreted by the signal interpretation unit, so as to match the instructions supported by the device to be controlled.

8. The remote control of claim 1, further comprising a card reading unit with a hot plug input/output technology for accessing a memory card, which provides an extra remote-control program module for the system-expandable remote control.

9. The remote control of claim 1, wherein the virtual remote-control interface is a manipulation interface of a proprietary remote control for the device to be controlled.

10. A method for expanding system for a system-expandable remote control with touch panel, comprising:
preparing a the system-expandable remote control with touch panel;
determining whether the system-expandable remote control with touch panel supports functioning the device to be controlled;
if the device to be controlled is supported, ifs to activate the corresponding remote-control program module for the device to be controlled;
if the device to be controlled is not supported by the system-expandable remote control with touch panel, the corresponding remote-control program module is loaded from an external memory medium; and
installing the remote-control program module, and executing the remote-control program module corresponding to the device to be controlled.

11. The method of claim 10, further comprising a matching procedure which is performed to determine whether the system-expandable remote control with touch panel supports functioning the device to be controlled or not.

12. The method of claim 10, further comprising a menu of virtual remote-control interfaces displayed on a display unit of the remote control, by viewing the menu, it determines whether the device to be controlled is supported or not.

13. The method of claim 10, if the device to be controlled is supported after the determination, the method further comprises a step for determining whether the remote-control program module has an update.

14. The method of claim 10, wherein the remote control has a memory unit to record one or more remote-control program modules.

15. The method of claim 14, wherein the remote-control program module is a package bundling a virtual remote-control interface, a file of remote-control key definition, and a remote-control instruction set.

16. The method of claim 15, wherein when then remote-control program module is executed, a signal interpreting means is used to interpret the remote-control key definition and the remote-control instruction set, so as to match the instructions supported by the device to be controlled.

17. The method of claim 10, wherein the external memory medium includes a memory card in accordance with a hot plug input/output technology.

18. The method of claim 10, wherein the external memory medium includes a memory built in a computer system which is accessed via USB.

19. The method of claim 10, wherein the external memory medium includes a downloadable space over a network.

20. The method of claim 19, wherein the remote control links the network via a built-in connecting port for downloading the remote-control program module.
